(19) United States
(12) Patent Application Publication
(10) Pub. No.: US 2018/0073288 A1
(43) Pub. Date: Mar. 15, 2018

(54) FOOT ACTUATED QUICK LOCKING APPARATUS

(71) Applicant: Kevin Webster, McCracken, KS (US)

(72) Inventor: Kevin Webster, McCracken, KS (US)

(21) Appl. No.: 15/266,442

(22) Filed: Sep. 15, 2016

(51) Int. Cl. E05C 19/00; E05B 53/00; E05B 15/16; E05C 1/12

(52) U.S. Cl. CPC E05C 19/00; E05C 1/12; E05B 15/1614; E05B 53/001

(57) ABSTRACT

A foot actuated quick locking apparatus is disclosed herein which is configured to quick lock a door during an emergency situation. The foot actuated quick locking apparatus comprises a spring loaded bolt, a sleeve, and a lever member. The spring loaded bolt is mounted at a bottom section of a door, and the sleeve positioned on the floor, where the sleeve is axially aligned to receive the spring loaded bolt when the door is in closed position. The lever member is connected to the spring loaded bolt, where a user is configured to actuate the lever member via foot to quick release the spring loaded bolt. The spring loaded bolt is received within the sleeve to quick lock the door.

### FIELD OF THE INVENTION

The present invention relates to door locking mechanisms and latches. More specifically the present invention relates to a foot actuated quick locking apparatus which is configured to immediately lock a door during an emergency situation, for example, a hostage situation or an active shooter on the loose.

### BACKGROUND

Hostage situations, home invasions, or active shooter situations are of serious concern these days. In most cases, most individuals fail to secure themselves from such criminals, for example, active shooters. The shooters, generally chase the hostages into a room and keep the room under their control, where the hostages are unable to escape. There is no method or apparatus to secure a user quickly behind a closed door before the shooters can reach in close proximity to take them as hostages. In most buildings, hinged doors are used to allow entry/exit from a room. In the conventional scenario, hinged doors can often be broken by exerting a physical force directly to the door surface, or the door knob and the connected lock mechanisms. A stealthy kick from an individual can collapse the door, or the door frame which is sufficient to break the door's locking mechanism, or cause severe damage to the door frame. Generally, such damage to doors occur during a hostage situation, or when a shooter is on the run. The shooters try to enter closed doors with brute force by kicking or shooting at the locked section.

However, a range of reinforcing security measures have been devised to avoid hinged doors from being broken by the exertion of external force, for example, prop bars. The prop bars just adjoin against the doors to grip them closed. The working of the prop bar is much like a door wedge, where prop bars work on the securing force of the prop against the floor to the rear of the door. Most security prop bars use unique brackets which are permanently positioned on to the floor. Others depend on friction to deliver their securing force. However, while conventional prop bars are normally operative at avoiding hinged doors opening inward toward the individual's side of the doorway, from being broken by force, they have several practical disadvantages. Firstly, the hinged door must open inward toward the individual, that is, if it opens outward away from the individual, a wedge or bar cannot work because the opening motion is away from the obstructing member. Another issue is that, the mounting brackets connected to the floor is usually impractical and not desired. Therefore, there is a need for a strong locking mechanism which can be quickly activated and locked during an emergency situation, such as, when an active shooter threatens to create a hostage situation.

### SUMMARY OF THE INVENTION

A foot actuated quick locking apparatus disclosed herein addresses the above mentioned issues. The foot actuated quick locking apparatus disclosed herein is configured to quick lock a door during an emergency situation. The foot actuated quick locking apparatus comprises a spring loaded bolt, a sleeve, and a lever member. The spring loaded bolt is mounted at a bottom section of a door, and a pin member extends from the spring loaded bolt which is engagable within a retaining groove positioned adjacent to the spring loaded bolt. The sleeve positioned on the floor, where the sleeve is axially aligned to receive the spring loaded bolt when the door is in closed position. The lever member is connected to the spring loaded bolt, where a user is configured to actuate the lever member via foot to quick release pin member of the spring loaded bolt from the retaining groove. Therefore, the spring force causes the spring loaded bolt to be thrusted into the sleeve to quick lock the door.

In an embodiment, the spring loaded bolt and the lever member are connected and attached to a first base plate fixedly attached to the bottom section of the door. In an embodiment, the spring loaded bolt and the first base plate are made of stainless steel material. In an embodiment, the bottom tip of the spring loaded bolt is rounded in shape to allow the spring loaded bolt to flexibly engage with the sleeve positioned on the floor. In an embodiment, the curvature of the sleeve pushes aligns and positions the bottom tip of the spring loaded bolt into a notch section, thereby preventing the spring loaded bolt from being plied from other side of the door. In an embodiment, a second base plate, made of hardened steel, is positioned opposing to the first base plate on the other side of the door to protect and provide support for the foot actuated quick locking apparatus. In an embodiment, the second base plate extends below the bottom section of the door to protect the spring loaded bolt from contacting the floor while opening and closing the door. In an embodiment, the second base plate is thicker than the first base plate.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 exemplarily illustrates a front perspective view of the foot actuated quick locking apparatus.

FIG. 2 exemplarily illustrates a front perspective view of a second base plate positioned opposing to the first base plate on the other side of the door.

FIG. 3 exemplarily illustrates a front perspective view of the door with the foot actuated quick locking apparatus, showing additional strips attached to the door.

### DETAILED DESCRIPTION OF THE INVENTION

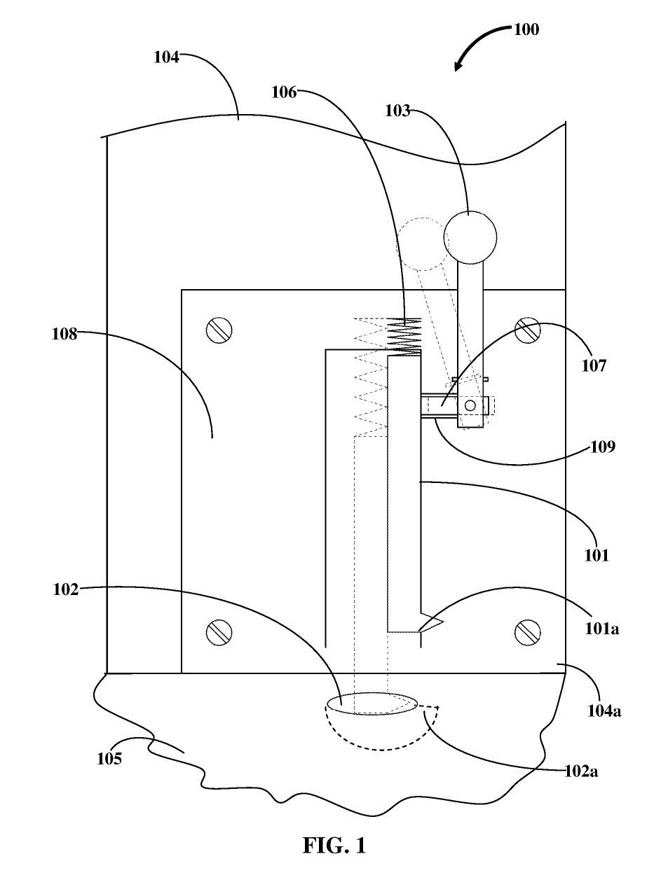

FIG. 1 exemplarily illustrates a front perspective view of the foot actuated quick locking apparatus 100. The foot actuated quick locking apparatus 100 is disclosed herein which is configured to quick lock a door 104 during an emergency situation in order to protect a user. The emergency situation, as disclosed herein, refers to hostage situations, home invasions, or active shooter situations, where the intruders chase the victims to keep them captive. In most cases, the shooters reach the user, or the victim, because the victim is not able to protect themselves from the shooter, on time, by shutting themselves safe behind closed doors 104. Even if the victims are able to secure themselves, the shooter normally forces their way in by applying force or shooting at the locking section. Therefore, the foot actuated quick locking apparatus 100 disclosed herein addresses this issue, where a user, or a victim being chased by a shooter can kick the locking mechanism defined by the foot actuated quick locking apparatus 100, and quickly secure the hinged door 104 before being contacted by the shooter. Further, the locking mechanism disclosed by the foot actuated quick locking apparatus 100 provides a rigid resistance against further intrusion from the shooter after the victim secures him/herself behind the door 104.

The foot actuated quick locking apparatus 100 comprises a spring loaded bolt 101, a sleeve 102, and a lever member 103. The spring 106 of the spring loaded bolt 101 is attached right above the bolt 101. The spring loaded bolt 101 is mounted at a bottom section 104a of a door 104, and a pin member 107 extends from the spring loaded bolt 101 which is engagable within a retaining groove 109 positioned adjacent to the spring loaded bolt 101. The sleeve 102 is positioned on the floor 105, where the sleeve 102 is axially aligned to receive the spring loaded bolt 101 when the door 104 is in closed position. The sleeve 102 is dug into the floor 105 for a predefined depth which is enough to receive the spring loaded bolt 101, as described further. The lever member 103 is connected to the spring loaded bolt 101, where a user is configured to actuate the lever member 103 via foot, that is, by kicking with force, to quick release pin member 107 of the spring loaded bolt 101 from the retaining groove 109. The spring force causes the spring loaded bolt 101 to be thrusted into the sleeve 102 to quick lock the door 104. That is, the user is required to kick the lever member 103 which allows the spring loaded bolt 101 to be disengaged from the connection with the lever member 103, which allows the spring loaded bolt 101 to fall down under gravity to the sleeve 102 that's axially aligned with the spring loaded bolt 101. Further, when danger situation is over, the spring loaded bolt 101 can simply be pulled back up and reset to the initial state.

The pin member 107 or a bolt handle provide a contact communication between the spring loaded bolt 101 and the lever member 103, where when the lever member 103 is kicked by the user, the bolt handle is disengaged from the interlocking notch, or the retaining groove 109, defined on the spring loaded bolt 101 which allows the spring loaded bolt 101 to fall down under gravity to the sleeve 102 that's axially aligned with the spring loaded bolt 101. In an embodiment, the spring loaded bolt 101 and the lever member 103 are connected and attached to a first base plate 108 fixedly attached to the bottom section of the door 104. The first base plate 108 is fastened to the door 104 via fasteners. In an embodiment, the spring loaded bolt 101 and the first base plate 108 are made of stainless steel material.

In an embodiment, the bottom tip 101a of the spring loaded bolt 101 is rounded in shape to allow the spring loaded bolt 101 to flexibly engage with the sleeve 102 positioned on the floor 105. In an embodiment, the curvature of the sleeve 102 pushes aligns and positions the bottom tip 101a of the spring loaded bolt 101 into a notch section 102a. The positioning of the bottom tip 101a of the spring loaded bolt 101 in the notch section 102a prevents the spring loaded bolt 101 from being plied from other side of the door. In comparison to conventional systems, the foot actuated quick locking apparatus 100 uses a positive locking system, where the spring loaded bolt 101 is locked in the retaining groove 109 in the housing, or the first base plate 108, via the pin member 107 which makes the foot actuated quick locking apparatus 100 more secure than a friction based retention system.

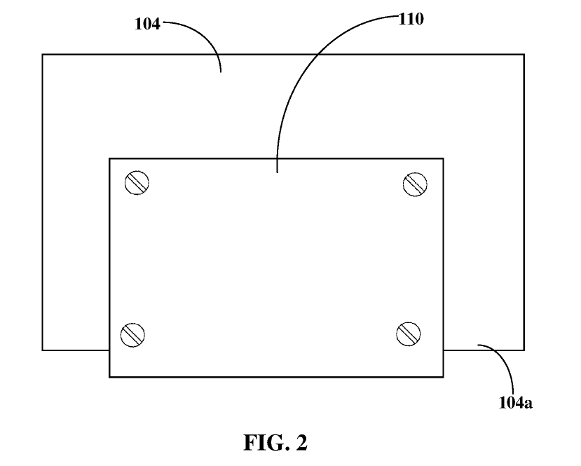

FIG. 2 exemplarily illustrates a front perspective view of a second base plate 110 positioned opposing to the first base plate 108 on the other side of the door 104. In an embodiment, a second base plate 110, made of hardened steel, is positioned opposing to the first base plate 108 on the other side of the door 104 to protect and provide support for the foot actuated quick locking apparatus 100, for example, against gunfire or prying. In an embodiment, the second base plate 110 extends below the bottom section 104a of the door 104 to protect the spring loaded bolt 101 from contacting the floor 105 while opening and closing the door 104. In an embodiment, the second base plate 110 is thicker than the first base plate, for example, thicker by about 3 inches.

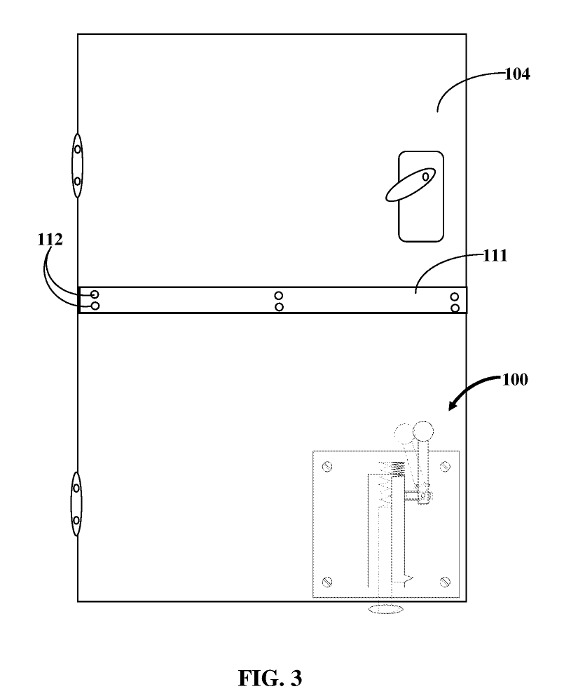

FIG. 3 exemplarily illustrates a front perspective view of the door 104 with the foot actuated quick locking apparatus 100, showing additional strips 111 attached to the door 104. As an additional safety measure, in an embodiment, two additional strips 111 of, for example, ½ inch by 1-inch stainless steel strips 111 are attached to the door 104 and the stainless steel strips 111 run along the length of the door 104 on both sides of the inside of the door 104. The stainless steel strips 111 would be attached with screws 112, and it prevents the door 104 from being sawed in half.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A foot actuated quick locking apparatus configured to quick lock a door during an emergency situation in order to protect a user, the foot actuated quick locking apparatus comprising:
a spring loaded bolt mounted at a bottom section of a door, wherein a pin member extends from the spring loaded bolt which is engagable within a retaining groove positioned adjacent to the spring loaded bolt;
a sleeve positioned on the floor, wherein the sleeve is axially aligned to receive the spring loaded bolt when the door is in closed position;
a lever member connected to the spring loaded bolt, wherein a user is configured to actuate the lever member via foot to quick release the pin member of the spring loaded bolt from the retaining groove, wherein spring force causes the spring loaded bolt to be thrusted into the sleeve to quick lock the door.

2. The foot actuated quick locking apparatus of claim 1, wherein the spring loaded bolt and the lever member are connected and attached to a first base plate fixedly attached to the bottom section of the door.

3. The foot actuated quick locking apparatus of claim 1, wherein the spring loaded bolt and the first base plate are made of stainless steel material.

4. The foot actuated quick locking apparatus of claim 1, wherein the bottom tip of the spring loaded bolt is rounded in shape to allow the spring loaded bolt to flexibly engage with the sleeve positioned on the floor.

5. The foot actuated quick locking apparatus of claim 4, wherein curvature of the sleeve pushes aligns and positions the bottom tip of the spring loaded bolt into a notch section, thereby preventing the spring loaded bolt from being plied from other side of the door.

6. The foot actuated quick locking apparatus of claim 1, wherein a second base plate, made of hardened steel, is positioned opposing to the first base plate on the other side of the door to protect and provide support for the foot actuated quick locking apparatus.

7. The foot actuated quick locking apparatus of claim 1, wherein the second base plate extends below the bottom section of the door to protect the spring loaded bolt from contacting the floor while opening and closing the door.

8. The foot actuated quick locking apparatus of claim 1, wherein the second base plate is thicker than the first base plate.
